(19) United States
(12) Patent Application Publication
(10) Pub. No.: US 2013/0179274 A1
(43) Pub. Date: Jul. 11, 2013

(54) MAP-BASED SOCIAL AND ADVERTISING NETWORK

(71) Applicant: ReJean DesRosiers, Mississauga (CA)

(72) Inventor: ReJean DesRosiers, Mississauga (CA)

(21) Appl. No.: 13/716,617

(22) Filed: Dec. 17, 2012

Related U.S. Application Data
(60) Provisional application No. 61/576,532, filed on Dec. 16, 2011.

(51) Int. Cl. G06Q 10/08

(52) U.S. Cl. CPC G06Q 10/087
USPC 705/14.72; 705/28

(57) ABSTRACT

A network that can be organized around a mapping function and that can be used for social, business, or other information is disclosed. This network can allow users and businesses to post advertisements for items and services for sale as well as items and services that are sought. It can also allow users to post reviews, both of businesses themselves as well as individual items in the businesses' inventories or on the businesses' menus. The network can allow businesses to post and manage coupons and promotions, and allow customers to follow particular businesses or even specific menu/inventory items so that they are notified of any related promotions.

### RELATED APPLICATIONS

This application claims priority to U.S. Provisional Application 61/576,532, filed Dec. 16, 2011 and entitled MAP-BASED SOCIAL AND ADVERTISING NETWORK, the entire contents of which are hereby incorporated by reference.

### BACKGROUND

Current search engines relating to searches for products and services are often difficult to use. Many provide results in text-only format, which makes locating the desired products and services difficult. While some search systems provide mapping functionality, the mapping interface is often poorly integrated with the search results, requiring the user to switch often between a text-based list interface and a location-aware map interface.

In addition, customer comments and reviews, when available, are often difficult to locate, as well as difficult to associate with a particular location. And, even on the most advanced location-based or location-aware products and services searches, it is difficult or impossible for a user to ascertain from the search results, or for a vendor to properly present, the state of a vendor's inventory at a particular location, or the presence or absence of sales or other promotional activity.

### SUMMARY

A network that can be organized around a mapping function and that can be used for social, business, or other information is disclosed. This network can allow users and businesses to post advertisements for items and services for sale as well as items and services that are sought. It can also allow users to post reviews, both of businesses themselves as well as individual items in the businesses' inventories or on the businesses' menus. The network can allow businesses to post and manage coupons and promotions.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary embodiment of a networked computer system.

FIG. 2 shows an exemplary embodiment of a process for creating and populating an inventory on an exemplary embodiment of the Uppost network.

FIG. 3A shows an exemplary embodiment of an inventory management page.

FIG. 3B shows an exemplary embodiment of an inventory management page with a pop-up which can be used to add an inventory item.

FIG. 3C shows an exemplary embodiment of a page which can allow a vendor to add an item to its inventory.

FIG. 3D shows an exemplary embodiment of a preview of an inventory item uppost.

FIG. 4 shows an exemplary embodiment of a process for creating a sale, coupon, or special on a map-based social and advertisement network.

FIG. 5A shows an exemplary embodiment of an inventory management page.

FIG. 5B shows an exemplary embodiment of page for creating the sale price, discount percentage and the expiry date of the sale of an item.

FIG. 6A shows an exemplary embodiment of a reservation confirmation page.

FIG. 6B shows an exemplary embodiment of a reservation page which can allow a user to track reservations he or she has made.

FIG. 7A shows an exemplary embodiment of a comment which a user has made on an item.

FIG. 7B shows an exemplary embodiment of a comment page that can show comments made by a user or made by others on the user's items or services.

FIG. 8 shows an exemplary embodiment of a process for searching using a map-based interface.

FIG. 9A shows an exemplary embodiment of a map-based results page.

FIG. 9B shows an exemplary embodiment of a map-based results page.

FIG. 10A shows an exemplary embodiment of an inbox for a message system.

FIG. 10B shows an exemplary embodiment of a draft message.

FIG. 10C shows an exemplary embodiment of a series of messages exchanged between a buyer and a seller.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

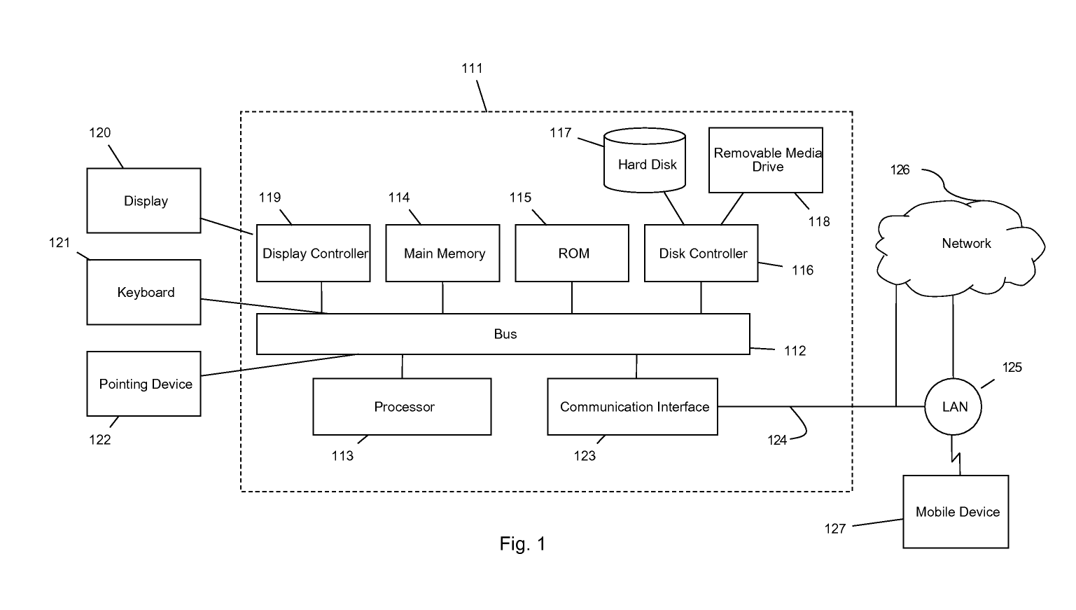

Generally referring to FIGS. 1-10C, a network that can be organized around a mapping function and that can be used for social, business, or other information is disclosed. This network can allow users and businesses to post advertisements for items and services for sale as well as items and services that are sought. It can also allow users to post reviews, both of businesses themselves as well as individual items in the businesses' inventories or on the businesses' menus. The network can allow businesses to easily post and manage coupons and promotions nearly instantaneously.

FIG. 1 illustrates an exemplary computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to bus 112 to control a display 120, such as a cathode ray tube (CRT), liquid crystal display (LCD) or any other type of display, for displaying information to a computer client. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

In some embodiments, computation, software, data access, storage, and any other desired function can be run, hosted, stored, or otherwise accomplished in a cloud-based, cloud-enabled, or otherwise cloud-related network, which can be low cost and easily expanded as needs require

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission.

In some exemplary embodiments, the Uppost network can include an inventory management system. The inventory management system can allow businesses or vendors such as retailers, wholesalers, or service providers to provide inventories of available items. The inventories can be fine-grained, and can allow a business or other vendor to provide information on each individual item, type of item, service, or type of service offered by the vendor. These inventories can be accessed through any desired searching tool known in the art, for instance search engines. In some exemplary embodiments, these inventories can be accessed by users through a map-based search engine implemented on a computer network, as described below. This can allow users to gather information on items or services offered by the business or vendor prior to or in preparation for purchase.

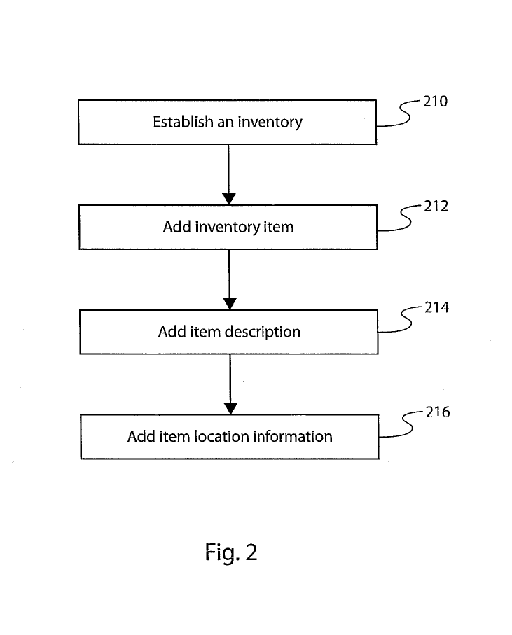

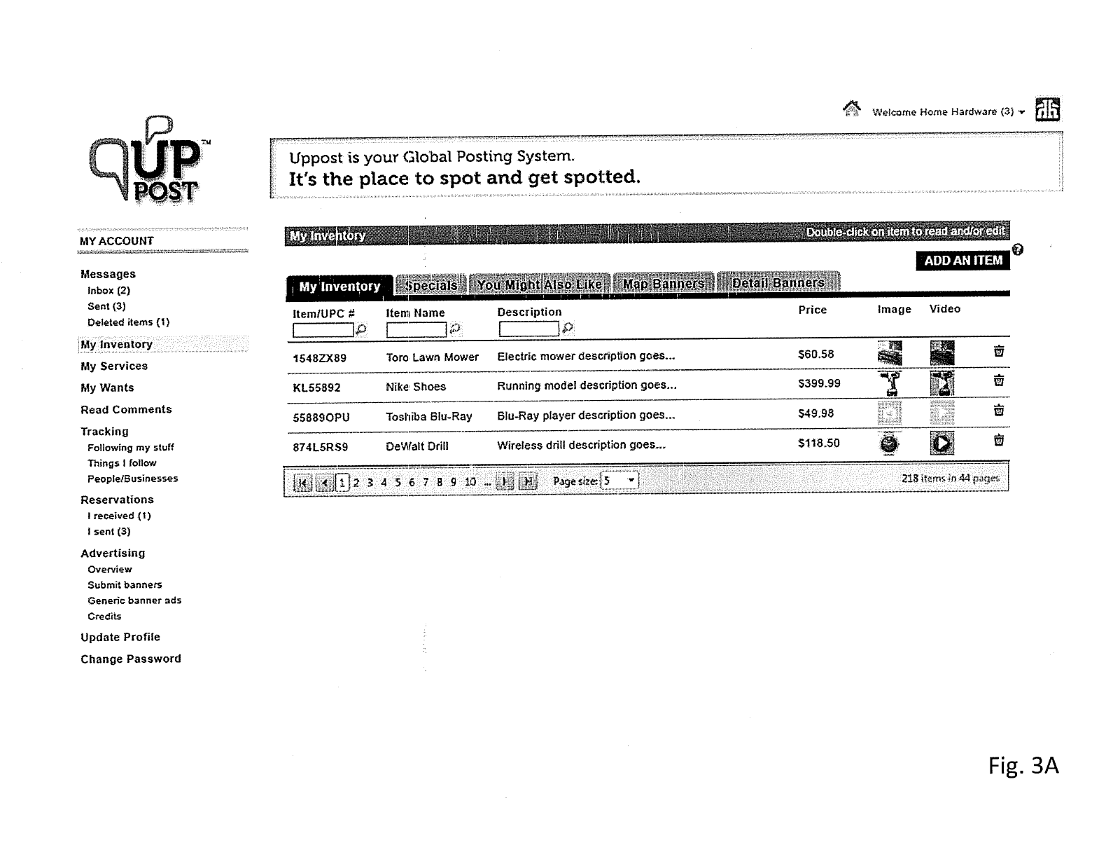

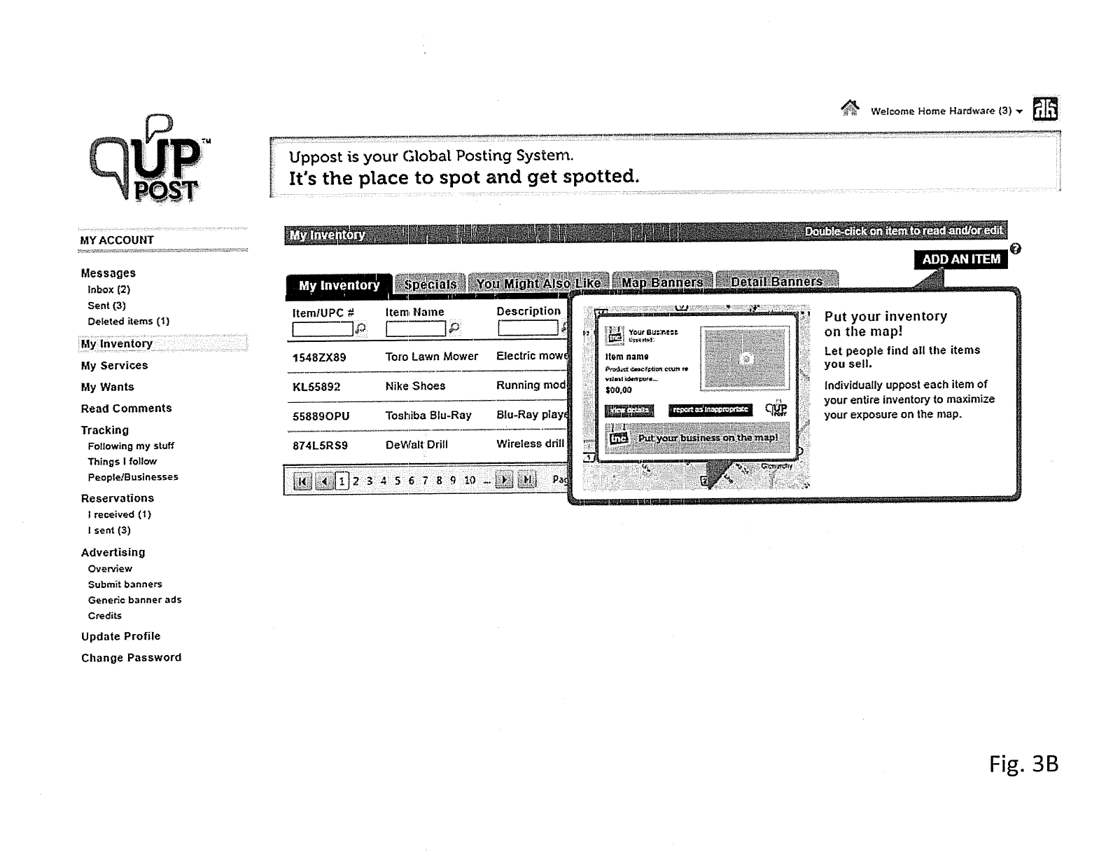

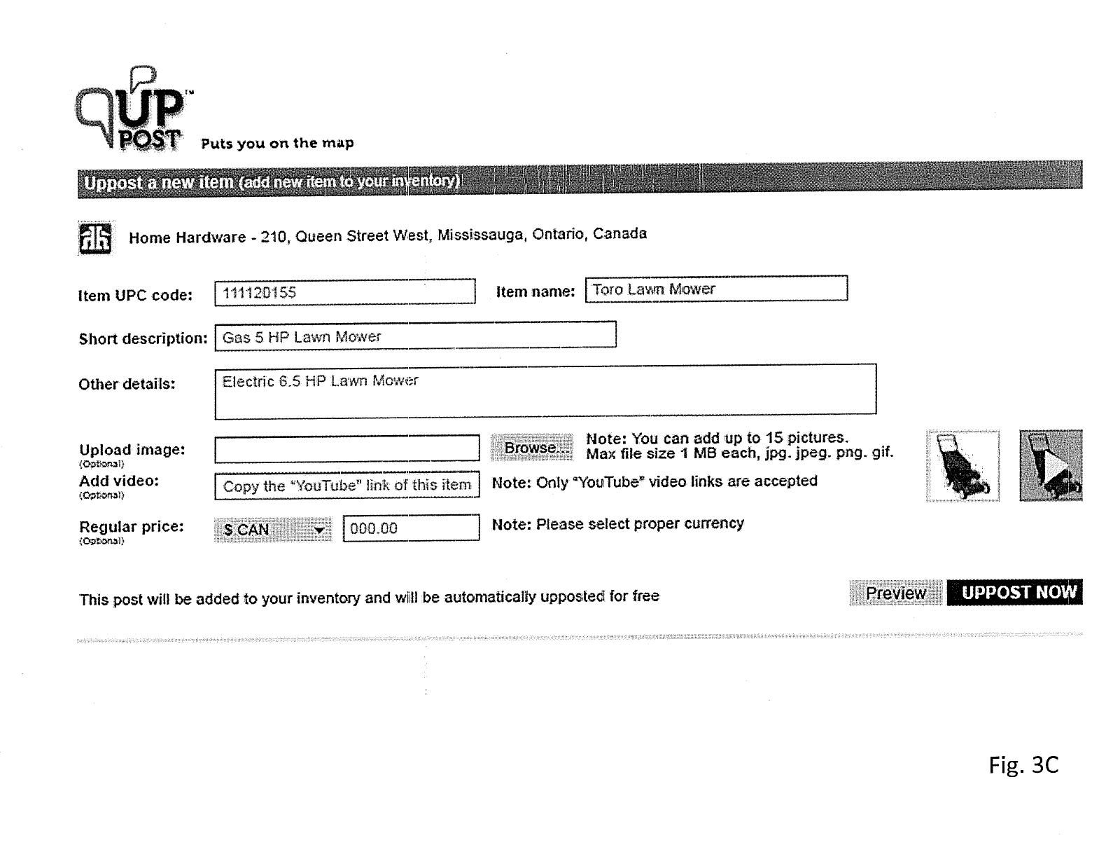

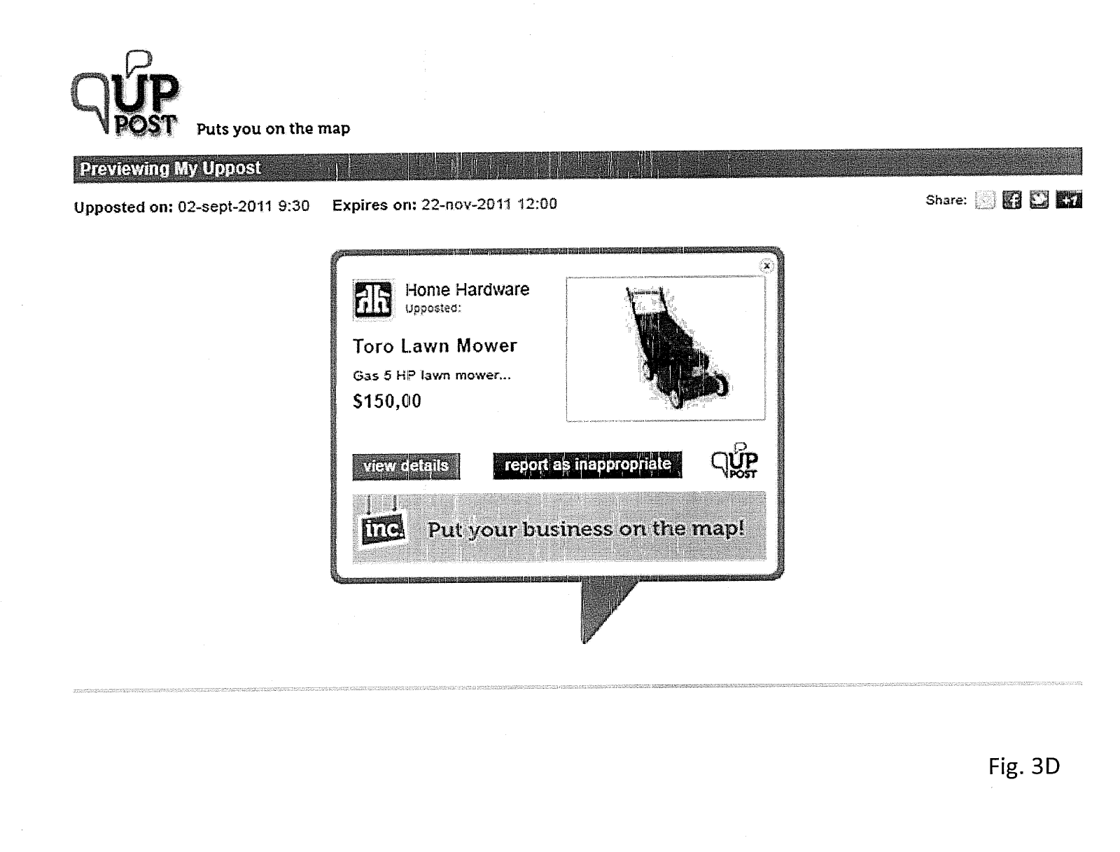

FIG. 2 shows an exemplary embodiment of a process for creating and populating an inventory on an exemplary embodiment of the Uppost network. At step 210, a vendor can establish an inventory. FIG. 3A shows an exemplary embodiment of an inventory management page, which can be used by a vendor to manage an inventory. This inventory can be associated with a single physical location, for example a storefront or warehouse, multiple physical locations, for example a chain of storefronts, or no physical location, as desired. At step 212, a vendor can add a listing for an item, type of item, service, or type of service to the inventory. FIG. 3B shows an exemplary embodiment of an inventory management page with a pop-up which can be used to add an inventory item. FIG. 3C shows an exemplary embodiment of a page which can allow a vendor to add an item to an inventory. If desired, vendors can create multiple separate inventories for separate locations, in order to provide, for example, separate sets of listings representing the current stock or current services offered at each particular location.

Still referring to FIG. 2, at step 214 a vendor can add descriptive information to an individual item listing. FIG. 3D shows an exemplary embodiment of a preview of an inventory item description. This descriptive information can be in any configuration, as desired. In some embodiments, the Uppost network can automatically create an in-depth informational post for each individual product or service. The in-depth informational post can be, for example, five pages long, and can consist of the product or service description, photos of the product or service, video of the product or service, comments from the public about the product or service, and a space for the user to send an electronic reservation for the product or service. In addition, the in-depth informational post can also include a tool to communicate with the vendor through a message system or other communication tool. The Uppost network can also generate a pop-up display which can be viewed on a map-based interface as a search result, as described below, and which can provide access to the in-depth informational post for a user viewing the map-based interface.

Still referring to FIG. 2, at step 216 a vendor can associate location information with a listing. The vendor can select to post each product or service at an exact address within a city, or within a city, or a number of cities, states or provinces, country or countries, or any other desired geographical area all over the world. This location information can be useful for users, and can be accessed by any desired search tool, for example a map-based search tool as described below.

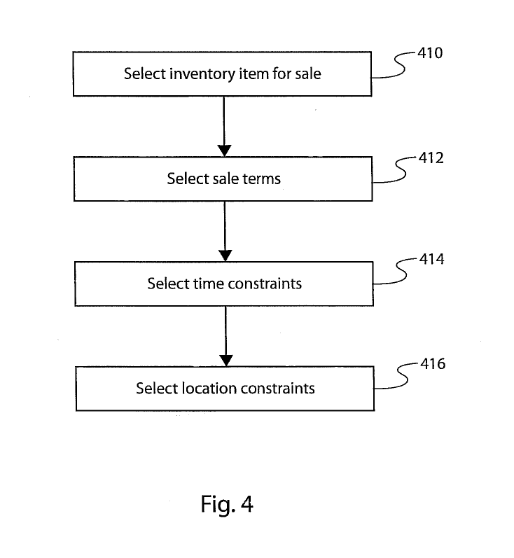

In some exemplary embodiments, the Uppost network can allow businesses or other vendors to conduct sales, create coupons, or offer a product or service under any other special condition. FIG. 4 shows an exemplary embodiment of a process for creating a sale, coupon, or special on an exemplary embodiment of the Uppost network. At step 410, a vendor can select an item to which the sale, coupon, or other special is to be applied. The vendor can select individual items, or can group items in any configuration as desired. At step 412, the vendor can select the terms of the sale. These terms can be any sale terms as desired, and can include any combination of special prices, discounts, or any other kinds of incentive. The terms can limit the sale to a certain number of products or services, and can list the number remaining, which can be updated by the vendor as the sale progresses. In some embodiments, the specials or other promotions can list the number of inquiries received for an item or service, or the number of purchases made of the item or service, and can compare these numbers to the number of items remaining, or any other desired information. At step 414, the vendor can select time constraints for the sale, if and as desired. The vendor can put an item on special at any time of the day, and can also end the sale at any time. The vendor can create sales, coupons, or other specials that can be for a set period of time and can be recurring, for instance hourly, daily, weekly, or any other desired period of time. At step 416, the vendor can set location constraints for the sale, coupon, or other special, if and as desired. The Uppost network can allow a vendor to to target any market or markets, as desired, by restricting the application of the special to particular physical locations.

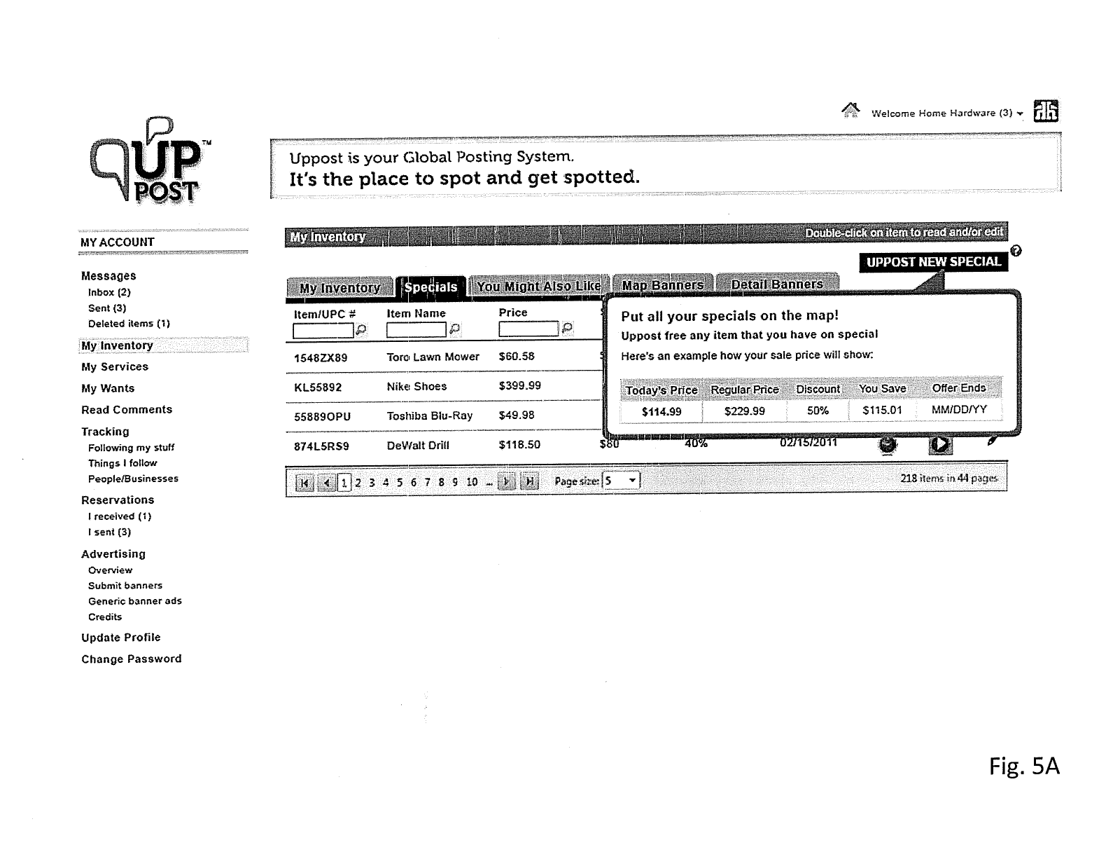

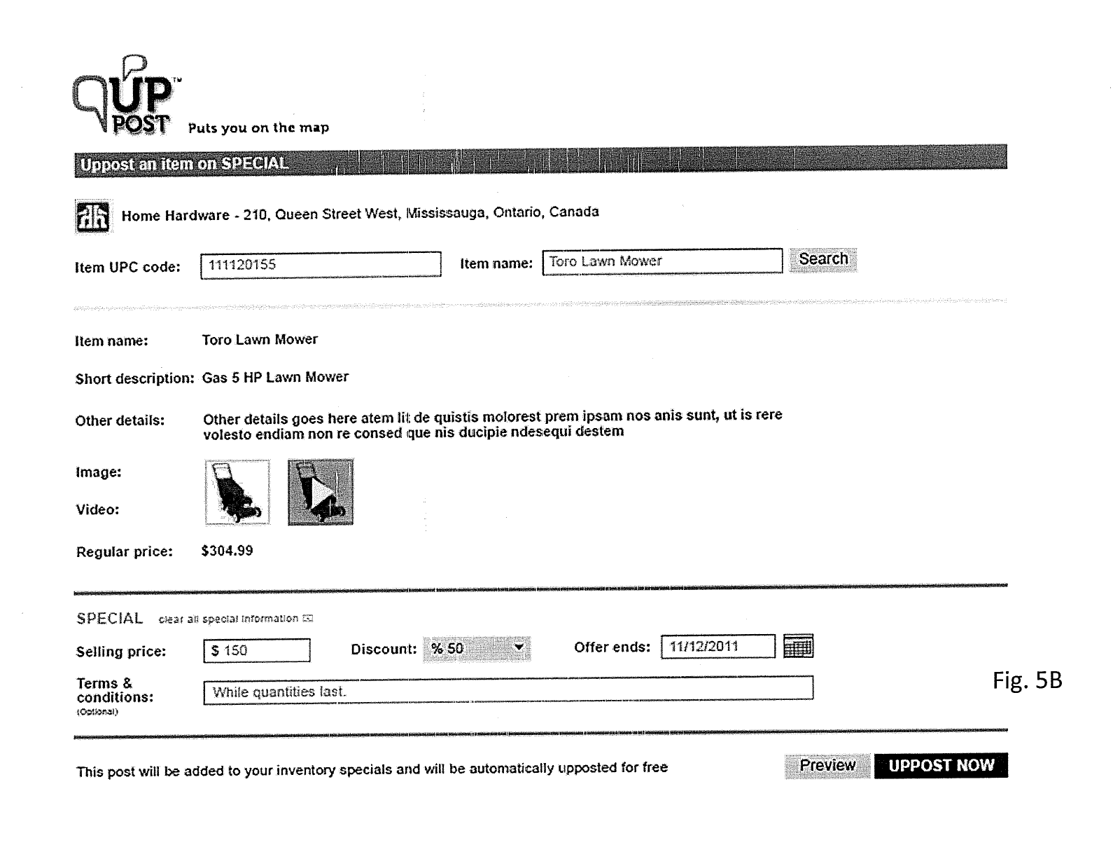

FIG. 5A shows an exemplary embodiment of an inventory management page which can allow a vendor to track specials, sales and other desired discounts. FIG. 5B shows an exemplary embodiment of a page for creating the sale price, discount percentage and the expiry date of the sale of an item.

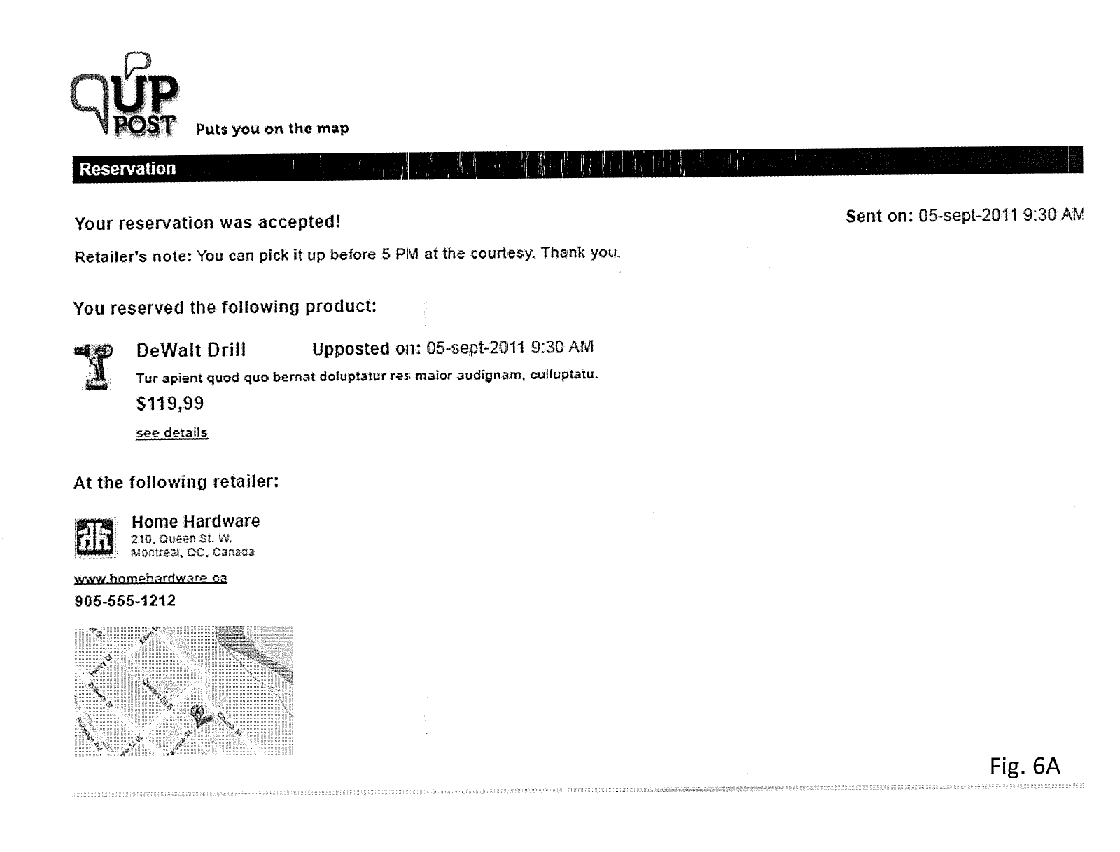

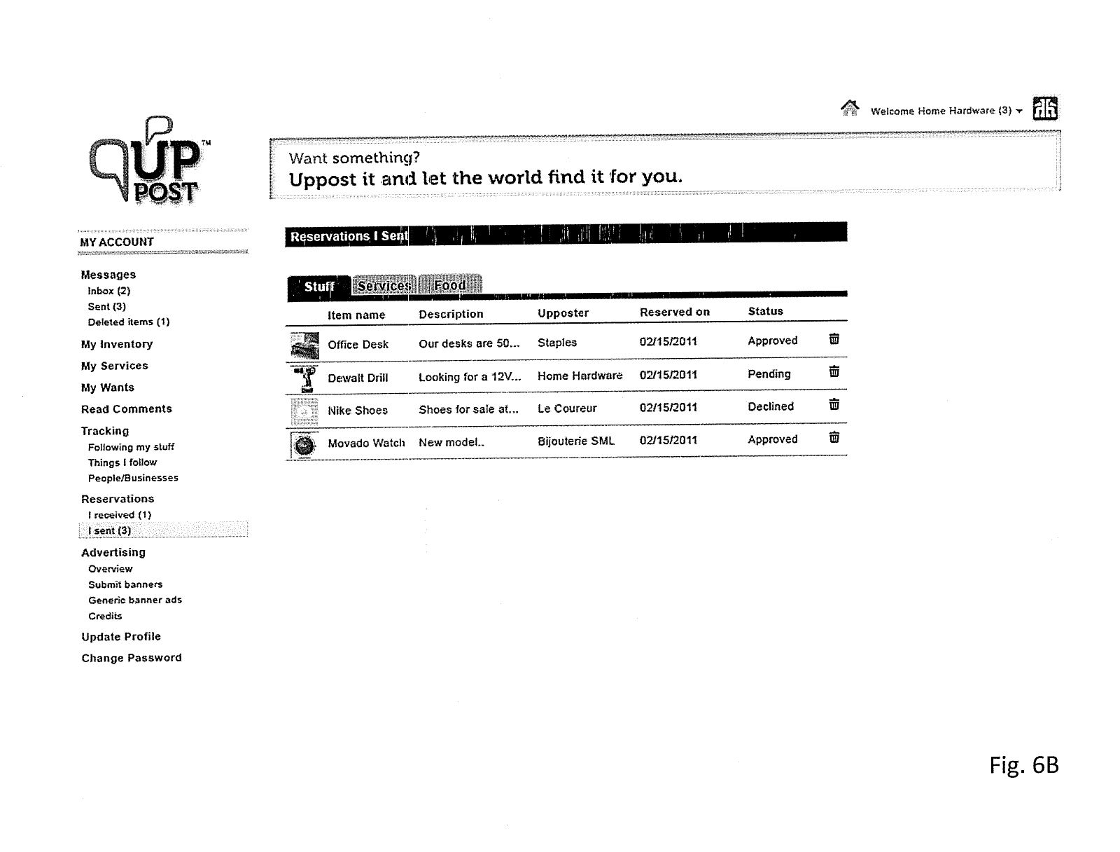

In some exemplary embodiments, the Uppost network can allow users to make reservations. Reservations can be made for a particular item or service or for a class of items or services. A vendor can set terms of the reservation, for example pick up times or limitations such as time limits. The vendor can associate a reservation with a sale, coupon, or other special, for example giving a discount on an item or service for making a reservation at a particular time. The vendor can require a deposit, if desired. FIG. 6A shows an exemplary embodiment of a reservation confirmation page. FIG. 6B shows an exemplary embodiment of a reservation page which can allow a user to track reservations that have been made. Reservations can be made for products, services, or any other inventory item as desired.

In some exemplary embodiments, the Uppost network can allow users to complete purchases entirely through the Uppost network. These purchases can be initiated from an in-depth informational post for an item or service, or from any other location or page. The Uppost network can allow a user to select an item or service for purchase, render payment, arrange delivery, receive confirmation, and undergo any other desired action in order to complete a sale.

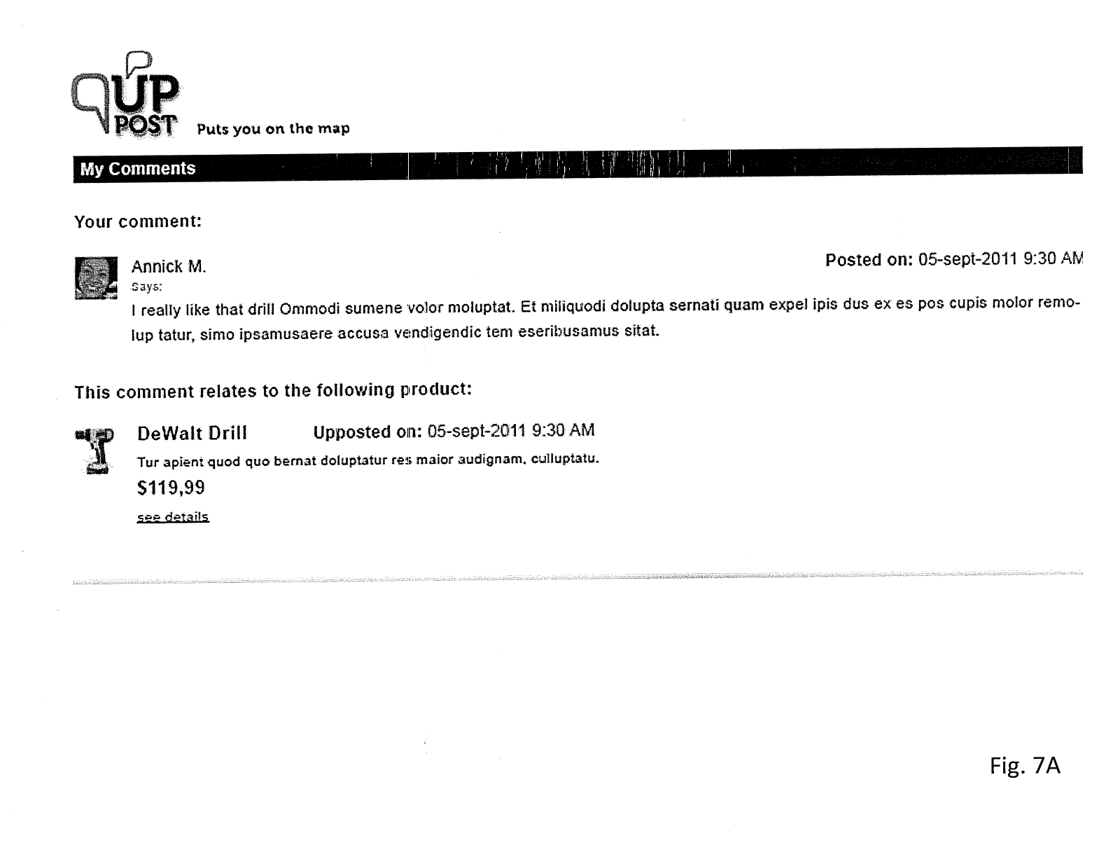

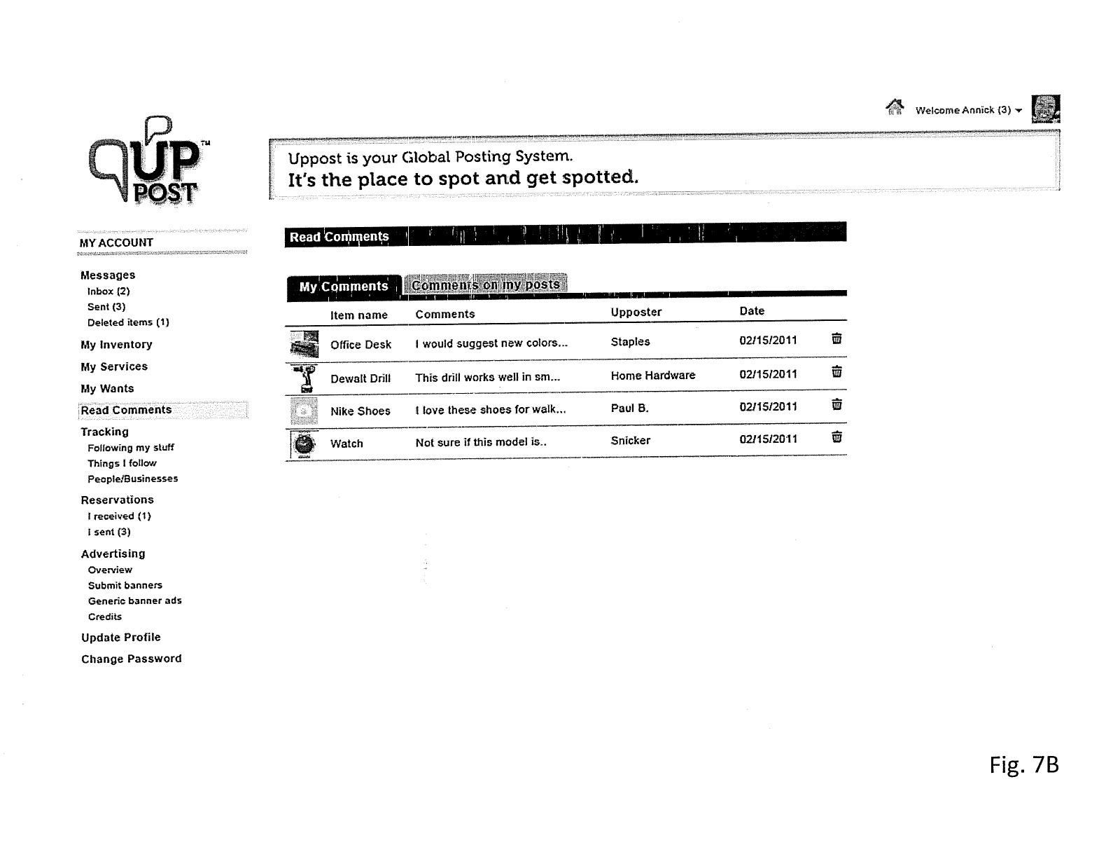

In some embodiments, the Uppost network can allow users to make and view comments. FIG. 7A shows an exemplary embodiment of a comment which a user has made on an item. FIG. 7B shows an exemplary embodiment of a comment page that can show comments made by a user or made by others on the user's items or services. Any user, including general public and business users, can comment on inventory items, services offered, business, or other users. Users can also make general posts tied to a specific geographical location or in any other desired manner. The comments can serve as reviews, as social communication, as reminders, as informational posts, or have any other desired function.

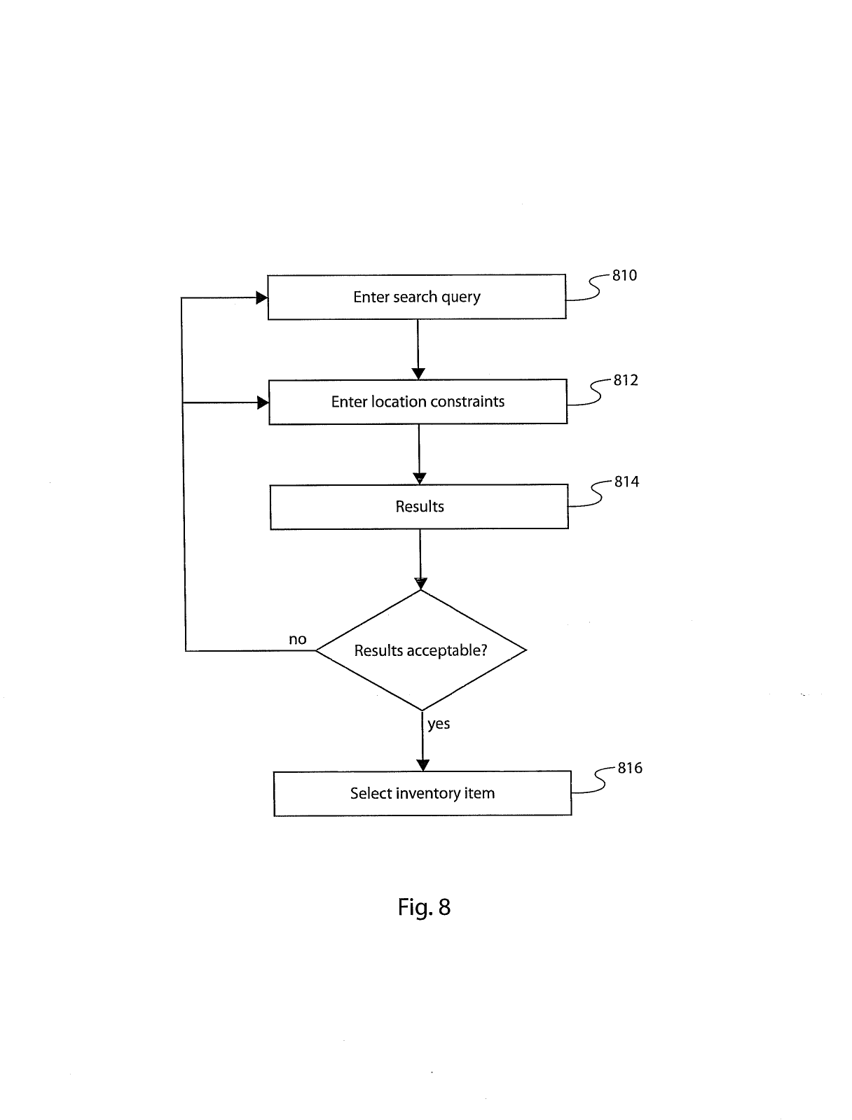

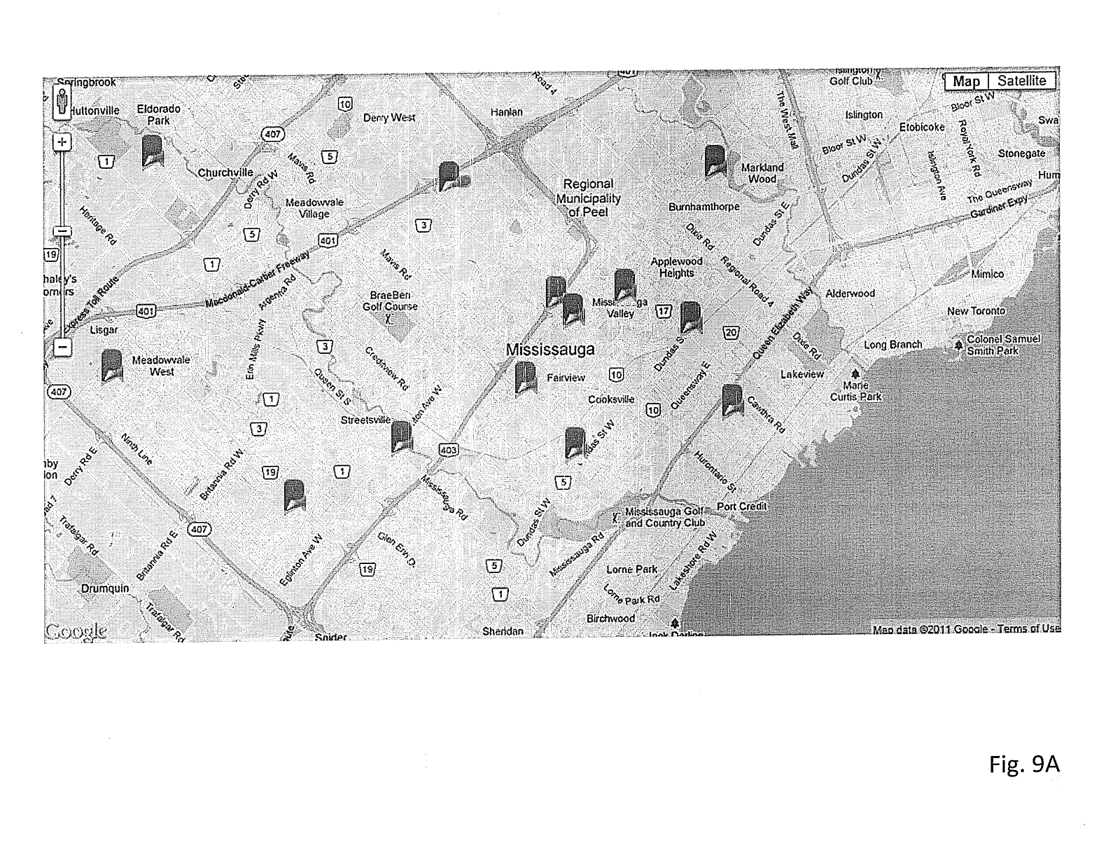

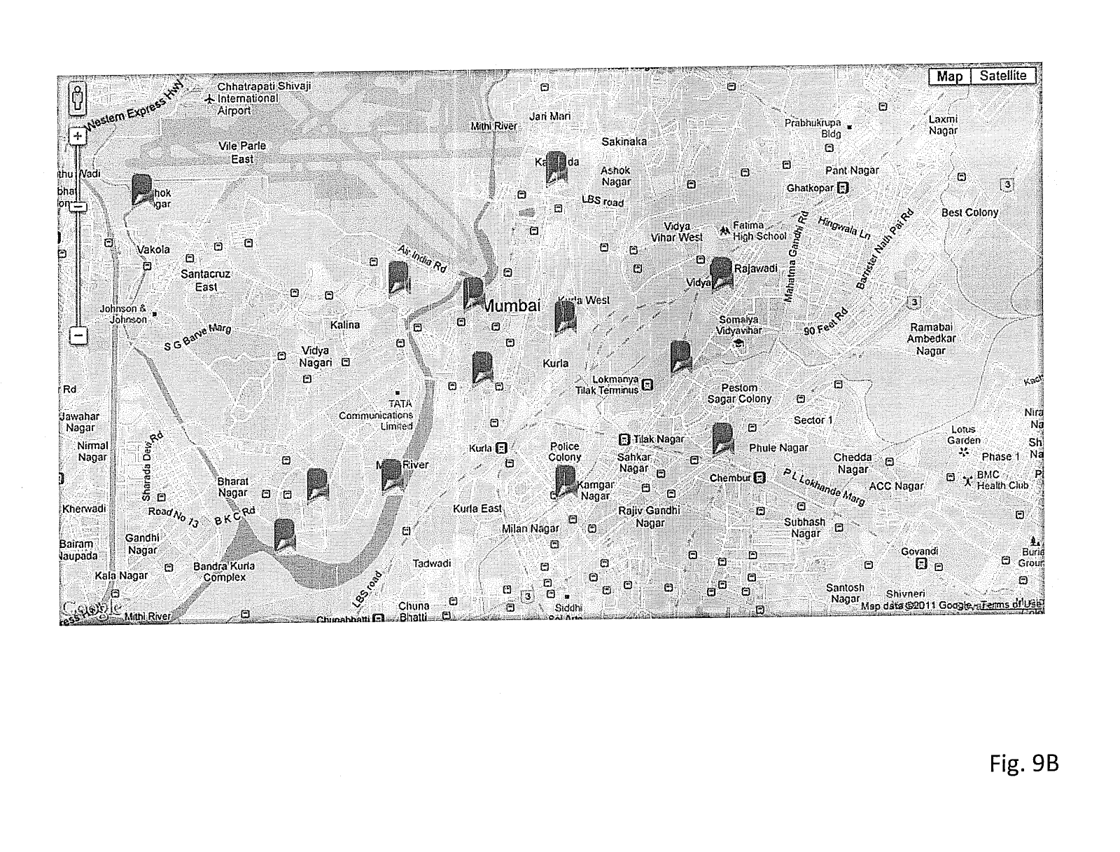

FIG. 8 shows an exemplary embodiment of a process for searching using a map-based interface. FIGS. 9A and 9B show an exemplary embodiment of a map-based results page. A user can search using any search tool, for example a networked computer system, a mobile communication device, or any other device or tool as desired. The results of the search can contain or include inventories that have been established by vendors, as described above. At step 810, the user can enter a search query. The search query can be in the form of a text query, and can be for example a name or description of a product or service. The search query can also be in the form of a picture, such as a picture of a product, or a picture of a product identifier such as the Universal Product Code (UPC). The Uppost network can interpret any type product identifier, for example UPCs, including UPC-B, UPC-C, UPC-D, or UPC-5, as well as European Article Numbers (EANs) or International Article Numbers, or any other type of barcode or other identification scheme. The search query can also take any other desired form, such as any type of scan or any other form as desired.

Still referring to FIG. 8, at step 812 the user can, if desired, enter a location to be associated with the search query. The user can enter the location by supplying coordinates, supplying a location identifier such as a place name, address, postal code such as Zone Improvement Plan (ZIP) code or any other code or identifier, as desired. The user can also enter the location using a map-based interface such as an interactive map. Using an interactive map, the user can zoom in, zoom out, relocate the viewing area, or perform any other interaction as desired. The location entered can be specific, or it can be a general location such as a city, county, state, country, region, continent, body of water, planet, or any other type of location.

Still referring to FIG. 8, at step 814 the user can review the results of the search. The user can review the results in any form, for example a list. In some embodiments, the results of the search can be displayed on a map-based interface such as an interactive map. The network can automatically return results containing vendors or other sellers organized by price, by location, by proximity to a desired location, or any other desired criteria. In some embodiments, the results can take the form of informational posts displayed on the map. The informational posts can represent inventory items in inventories associated with physical locations by vendors as described above. Users can select the map boundaries used to display the results of a search as well as the desired size of the results displayed, for example from within 1 block to all over the world. Results can include, for example, businesses or vendors with a physical location, and can also include business, vendors, and other entities which are online-only.

Users can determine whether the results supplied at step 814 are acceptable. If one or more of the displayed results are acceptable, the user can move to step 816 and interact with the results by, for example, selecting an informational post that can provide more information. If none of the results are acceptable, the user can return to step 810 in order to enter different search criteria, or to step 812 in order to refine the desired location by manipulating the map-based interface, for example by moving the map or by zooming in and out.

In some exemplary embodiments, the Uppost network can make use of voice integration. Any function described in this application can be accomplished through the use of voice-based commands, including creating upposts, executing searches, navigating interfaces, and any other desired function.

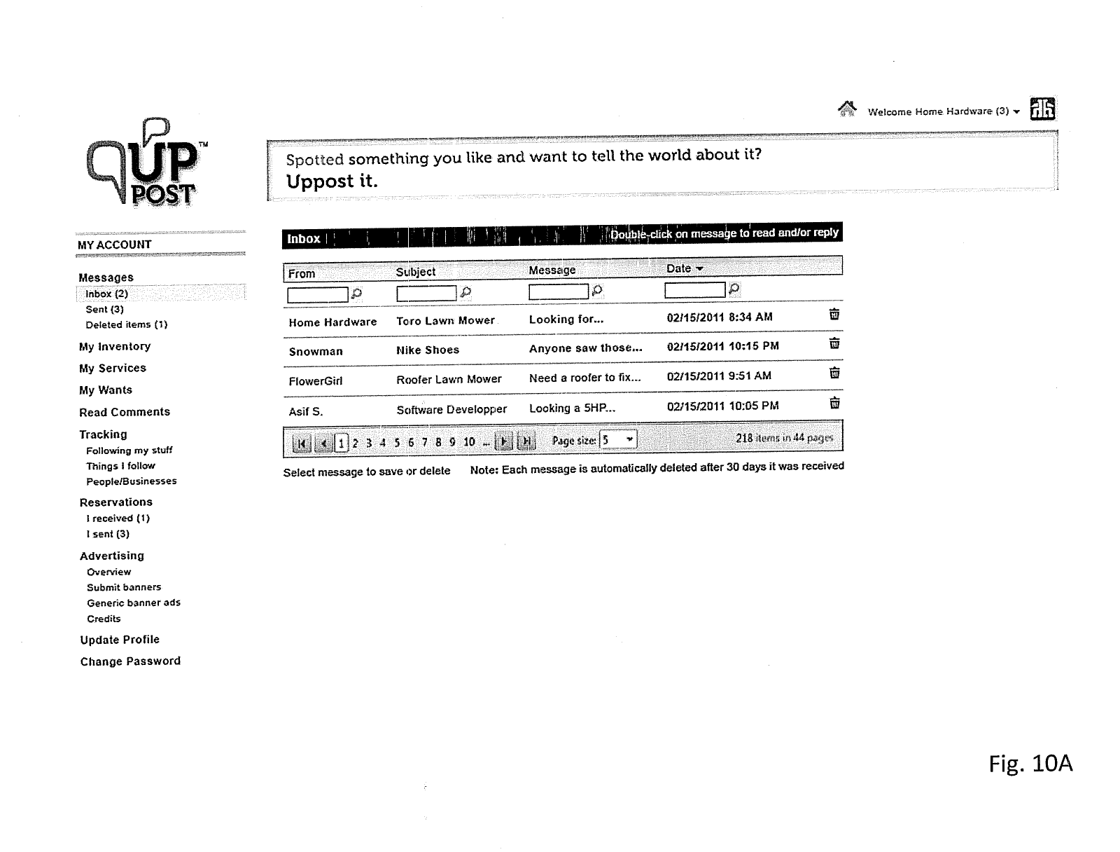

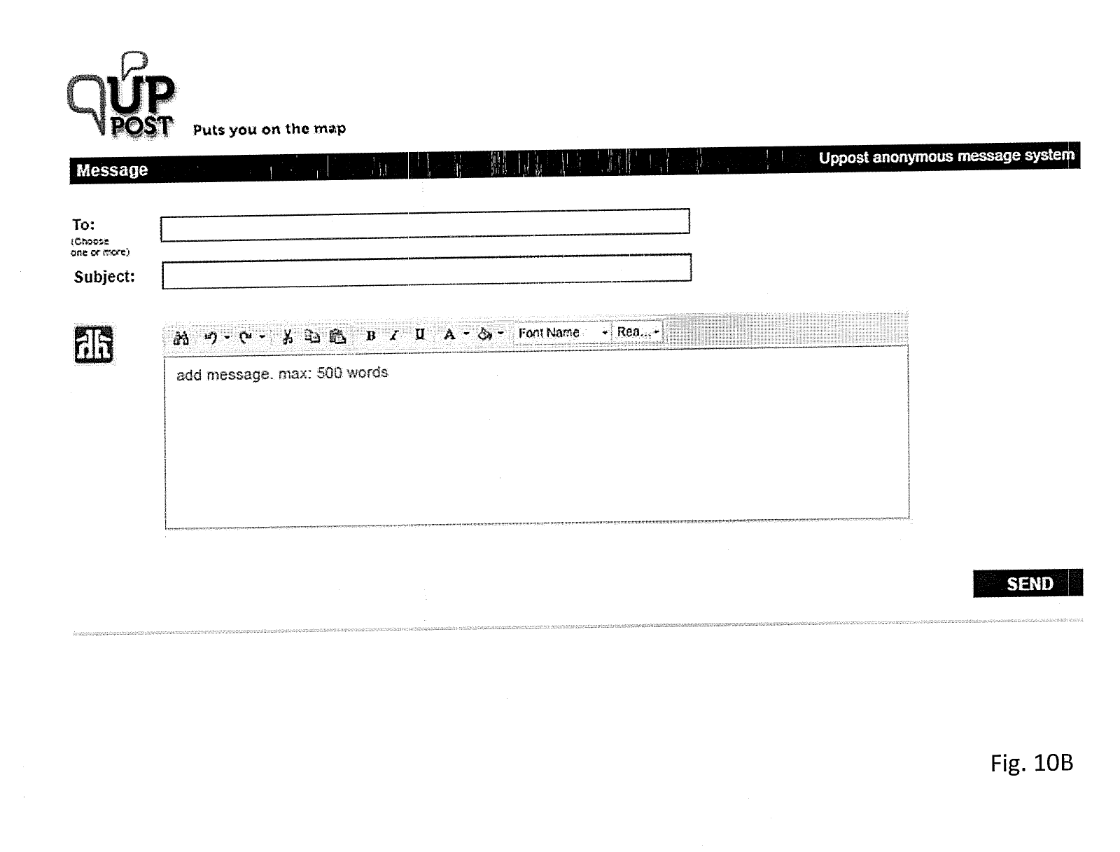

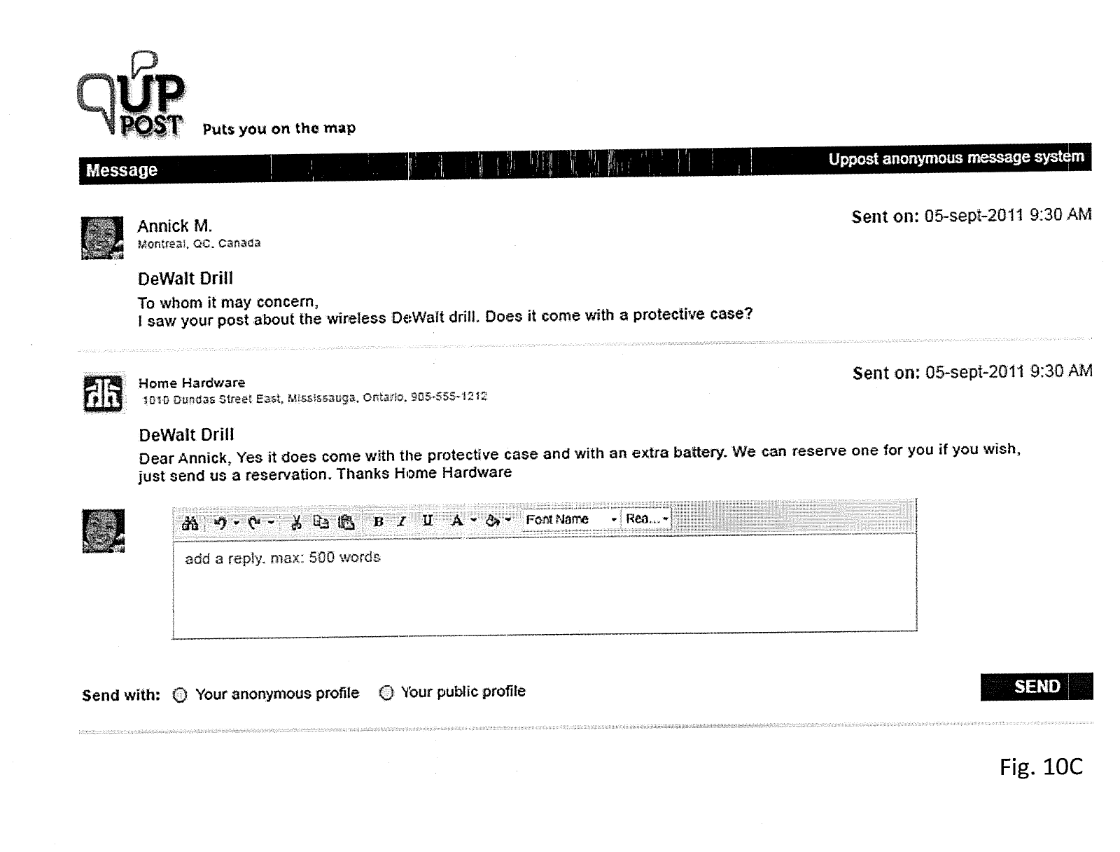

In some exemplary embodiments, the Uppost network can allow anonymous or pseudonymous communication between users of the service, for example between buyers and sellers. FIG. 10A shows an exemplary embodiment of an inbox for a message system. FIG. 10B shows an exemplary embodiment of a draft message, and FIG. 10C shows an exemplary embodiment of a series of messages exchanged between a buyer and a seller. These messages can be exchanged, for instance, between a business selling a product or services and one or more users interested in the product or service, or between a potential buyer of a product and another user who has already bought that same or similar product, or for any other desired communication between any combination of users, vendors, and any other participants. The messages can be sent anonymously, or pseudonymously using a nickname or username, so that, for example, a user's personal details are not exposed before the user wishes them to be.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for creating and managing an inventory, comprising:
establishing an inventory;
adding one or more inventory items to the inventory;
associating item description information with the one or more inventory items; and
associating item location information with the one or more inventory items;
wherein the inventory is searchable and at least one of the item description information or item location information are used to display the results of inventory searches on a map-based interface.

2. The method of claim 1, wherein the inventory items are at least one of a product or a service.

3. The method of claim 1, wherein the results of inventory searches are organized by at least one of price, current location, or proximity to a desired location.

4. The method of claim 1, wherein a user interacts with the map-based interface by redefining the boundaries of the map-based interface.

5. The method of claim 1, wherein the item description information includes at least one of an item description, a photograph of the item, a video of the item, comments about the item from a previous purchaser of the item, or information regarding the terms and procedures for sale of the item.

6. The method of claim 1, further comprising sending one or messages between a creator of an inventory and a user.

7. The method of claim 1, further comprising:
selecting an item for a special sale;
selecting sale terms for the special sale;
selecting time constraints for the special sale;
selecting location constraints for the special sale;
wherein at least one of the sale terms, time constraints, or location constraints are included in the inventory search results.

8. The method of claim 7, wherein the terms for the special sale include at least one of an item purchase limit or a total number of items to be sold in the special sale.

9. The method of claim 7, wherein the location constraints of the special sale restrict the special sale to a specific location.

10. The method of claim 7, wherein the inventory search results include at least one of the number of items remaining, the number of items sold, or the number of search queries received.
